(19) United States
(12) Patent Application Publication
(10) Pub. No.: US 2026/0310975 A1
(43) Pub. Date: Oct. 8, 2026

(54) Training and Using a Neuromodulation Large Language Model for Neuromodulation

(71) Applicant: Reach Neuro, Inc., Providence, RI (US)

(72) Inventors: Marc Philip Powell, Bristol, RI (US); Marco Capogrosso, Pittsburgh, PA (US); Douglas Weber, Pittsburgh, PA (US); Amir Barati Farimani, Pittsburgh, PA (US)

(21) Appl. No.: 19/637,214

(22) Filed: Apr. 2, 2026

Related U.S. Application Data
(60) Provisional application No. 63/784,418, filed on Apr. 7, 2025.

(51) Int. Cl. G06N 3/0895

(52) U.S. Cl. CPC G06N 3/0895

(57) ABSTRACT

The disclosure includes a system and method for obtaining, at a stimulator, a set of kinematic parameters at least one kinematic parameter determined specifically for a subject, at least in part, by a first machine learning algorithm neuromodulation large language model (LLM); and delivering, by the stimulator, electrical stimulation via an electrode array, the electrical stimulation defined by the set of kinematic parameters, wherein the electrode array comprises a plurality of electrodes, the electrode array is functionally coupled to a nervous system of the subject by electrical stimulation, and, subsequent to delivering the electrical stimulation defined by the set of kinematic parameters to the subject, the subject achieves a physiological function with reduced motor impairment.

### CROSS-REFERENCE TO RELATED APPLICATIONS

The present application claims priority to U.S. Provisional Patent Application No. 63/784,418, titled " Machine Learning for Spinal Cord Stimulation," and filed Apr. 7, 2026, the contents of which are hereby incorporated by reference in their entirety.

### BACKGROUND

Conditions such as stroke may leave an individual without the use of one or more limbs. One of the oldest device-based approaches to stroke treatment is functional electrical stimulation, which bypasses the corticospinal tract and stimulates individual muscles directly.

Spinal cord stimulation has been used to treat a variety of disorders including pain management. Spinal cord stimulation for pain management involves manually searching for stimulation parameters that yield analgesic effects.

### SUMMARY

This specification relates to methods and systems for training and/or using a neuromodulation large language model for neuromodulation. In some implementations, the system may include an array with a plurality of electrodes, the electrode array being functionally coupled to a nervous system of a subject by electrical stimulation, the electrical stimulation reducing motor impairment in the subject so that the subject may perform a physiological function; and a stimulator delivering the electrical stimulation via the electrode array, the electrical stimulation defined by a set of kinematic parameters, where: at least one kinematic parameter in the set of kinematic parameters is: determined, at least in part, by a neuromodulation large language model (LLM), specifically for the subject; and responsive to a prompt and based on subject-specific context data. The system also includes when the set of kinematic parameters are delivered to the subject, the subject achieves a physiological function with reduced motor impairment.

In some implementations the method includes obtaining, at a stimulator, a set of kinematic parameters at least one kinematic parameter determined specifically for a subject, at least in part, by a first machine learning algorithm neuromodulation large language model (LLM); and delivering, by the stimulator, electrical stimulation via an electrode array, the electrical stimulation defined by the set of kinematic parameters, wherein the electrode array comprises a plurality of electrodes, the electrode array is functionally coupled to a nervous system of the subject by electrical stimulation, and, subsequent to delivering the electrical stimulation defined by the set of kinematic parameters to the subject, the subject achieves a physiological function with reduced motor impairment.

Other implementations of one or more of these aspects include corresponding systems, apparatus, and computer programs, configured to perform the actions of the methods, encoded on computer storage devices.

These and other implementations may each optionally include one or more of the following features. For instance, in some implementations, the subject-specific context data may include one or more of: a neuromuscular map specific to the subject; a kinematic model specific to the subject; and a patient history representing the subject’s prior interactions with the neuromodulation LLM. For instance, in some implementations, the system may include: a processor; and a memory, the memory storing instructions that, when executed by the processor, cause the system to: obtain a base large language model LLM; obtain domain knowledge data; train a first intermediary LLM by pretraining the base LLM using the domain knowledge data; tune the first intermediary model based on a plurality of prompt-response pairs; perform preference optimization; and output the neuromodulation LLM. For instance, in some implementations, one or more of the base LLM and the neuromodulation LLM are an open weight model. For instance, in some implementations, the base LLM is a self-hosted model selected from one or more of: large language model meta artificial intelligence (Llama), Mistral, Gemma, Qwen, Deepseek, and Command R+. For instance, in some implementations, the domain knowledge data may include one or more of: curated scientific or clinical literature related to one or more of: neuromuscular rehabilitation, implantable stimulation systems, muscle activation dynamics, and biomechanical motor control; publications or technical reports describing one or more of: stimulation strategies, rehabilitation protocols, and observed physiological responses; medical or anatomy texts describing a neuromuscular system; scientific journals; textbooks; and text describing clinical trials. For instance, in some implementations, the plurality of prompt-response pairs, include a subset of prompt-response pairs based on the domain knowledge data. For instance, in some implementations, the plurality of prompt-response pairs, includes a subset of prompt-response pairs based on patient history, the patient history associated with prior prompts associated with one or more patients and prior responses output by one or more of a clinician and a prior version of the neuromodulation LLM. For instance, in some implementations, one or more of the tuning and the preference optimization may include: one or more of supervised fine-tuning, full fine-tuning, parameter-efficient fine-tuning, reinforcement learning from human feedback, direct preference optimization, proximal policy optimization, and odds ratio preference optimization. For instance, in some implementations, the user prompt is a natural language prompt regarding one or more of the subject’s physiological function and the set of kinematic parameters delivered to the subject; receive a response including the at least one kinematic parameter in the set of kinematic parameters, the at least one kinematic parameter determined, at least in part, by the neuromodulation LLM and modifying a prior value; and cause the stimulator to deliver the set of kinematic parameters to the subject.

The features and advantages described herein are not all-inclusive and many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1A illustrates a block diagram of one example system for neuromodulation using spinal cord stimulation in accordance with some implementations.

FIG. 1B illustrates an example of an electrode array that comprises two linear array segments implanted in a patient’s cervical spine in accordance with some implementations.

FIG. 2 illustrates a block diagram of an example computing device in accordance with some implementations.

FIG. 3 illustrates a block diagram of an example neuromodulation determination engine for spinal cord stimulation in accordance with some implementations.

FIG. 4 illustrates a block diagram of an example neuromodulation LLM trainer in accordance with some implementations.

FIG. 5 illustrates a block diagram of an example neuromodulation stimulation engine in accordance with some implementations.

FIG. 6 illustrates a flowchart of an example method for neuromodulation using spinal stimulation and a neuromodulation large language model in accordance with some implementations.

FIG. 7 illustrates a flowchart of an example method for training a neuromodulation large language model in accordance with some implementations.

FIG. 8 illustrates an example plot representing muscle activation based on mono-polar stimulation of a 5R electrode that may represent a portion of a neuromuscular mapping in accordance with some implementations.

FIG. 9 illustrates an example of an anatomical representation of muscle activation based on mono-polar stimulation of a 5R electrode to a particular subject in accordance with some implementations.

FIG. 10 illustrates examples muscle activation based on mono-polar stimulation of various electrodes to a particular subject in accordance with some implementations.

### DETAILED DESCRIPTION

Conditions such as stroke may leave an individual without the use of one or more limbs. One of the oldest device-based approaches for stroke treatment is functional electrical stimulation, which bypasses the corticospinal tract and stimulates individual muscles directly. Thus, the functional electrical stimulation forces involuntary activation of muscles, which tends to cause rapid fatigue. Moreover, the electrical stimulation through the skin tends to be uncomfortable, and coordinating the activation of synergistic muscle groups has proved difficult. Despite decades of research into functional electrical stimulation assisted rehabilitation, there has been little evidence demonstrating the benefits of functional electrical stimulation. Additionally, the foregoing approaches do not restore direct brain control over movement and/or reduce motor impairment, which may be provided by the systems and methods described herein.

Spinal cord stimulation (SCS) has been used to treat a variety of disorders including pain management. Spinal cord stimulation for pain management involves manually searching for stimulation parameters that yield analgesic effects. As described herein, spinal cord stimulation may be applied to recover the usage of limbs. However, the application of spinal cord stimulation to regain at least partial usage of limbs is associated with a number of challenges; one or more of which are at least partially overcome by the description here.

A first challenge is that, while pain treatment is binary (e.g., better or worse), using spinal cord stimulation to promote recovery of limb function is more complex. For example, spinal cord stimulation to promote recovery of limb function may require the identification of multiple sets of electrodes and stimulation parameters to achieve targeted treatment of deficits across multiple muscles. These sets of electrodes and stimulation parameters may occasionally be referred to, cumulatively or individually, herein as “kinematic parameters,” “kinematic parameter set,” “neuromodulation,” “kinematic models,” or similar.

A second challenge with using spinal cord stimulation to treat motor dysfunction is the heterogeneity of the population being treated. For example, where the population being treated includes stroke victims, each patient (i.e., stroke victim) may have a unique set of deficits. As another example, each patient may have a slightly different physiology (e.g., muscle strength, nerve condition, epidural space, etc.), and/or the implantation of the electrode(s) may vary (e.g., from patient-to-patient and/or in relative alignment vertebrae-to-vertebrae within a patient).

A third challenge is identifying kinematic parameters to ensure balanced facilitation of all targeted muscle groups, since stimulation to perform a task (e.g., reaching) may affect opposing muscles (e.g., bicep and triceps).

It should also be understood from the forgoing challenges that, to treat motor dysfunction using spinal cord stimulation, it may be desirable to personalize the kinematic parameters to treat an individual patient, which raises one or more additional challenges.

Additional challenges include, but not limited to, the large parameter space (e.g., given the number of permutations or combinations of the multiple electrodes that may be stimulated, the number of parameters that may define the stimulation, and the potential values of each of those parameters.), the amount of time it takes to explore the parameter space and find an optimum set of parameters in that space, particularly using a human-implemented guess-and-check approach, and the number of times it must be repeated for different spaces (e.g., for different muscles or muscle groups, different limbs, different kinematic tasks, etc.), the high degree of training for a human programmer or clinician to make educated guesses to be checked during the guess-and-check approach, availability of trained programmers or clinicians to make adjustments and attend clinical sessions, etc. Furthermore, the “optimum” parameters may change over time, e.g., due to one or more of neuroplasticity, rehabilitation, physical therapy, exercise, healing, deterioration, etc.

It should be understood that the foregoing challenges are merely exemplary and that others may exist and that one or more of the challenges are at least partially addressed by the description herein.

It should be recognized that the description, language, and examples herein are selected for clarity and convenience. Therefore, while the present disclosure makes frequent reference to treating stroke patients, the upper limbs and associated movements, implantation in epidural spaces and vertebrae in the human neck, a reaching task, etc. It should be understood that these are provided as non-limiting examples and that variations are within the scope of this disclosure. For example, a person having ordinary skill may recognize that placing electrodes in the epidural space of the lumbar and/or sacral spine to restore lower limb function, e.g., to perform a task such as like climbing stairs is within the present disclosure.

### Example System

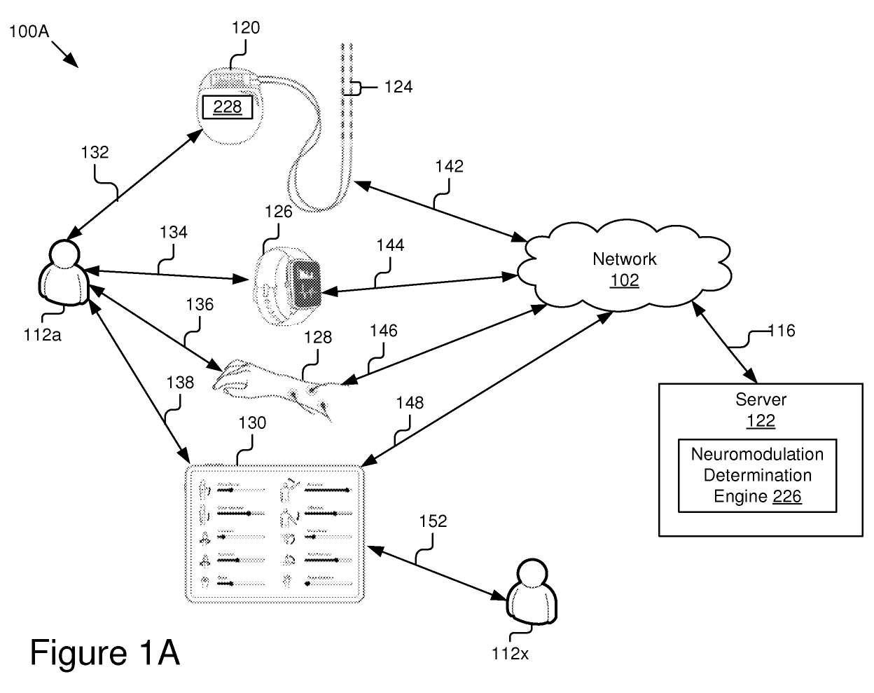

FIG. 1A is a block diagram of an example system 100 for limb function recovery based on neuromodulation in accordance with some implementations. In the illustrated implementation, the system 100 includes a server 122 communicatively coupled for electronic communication with a stimulator 120 that is coupled to an array of electrodes 124, a wearable sensor 126, a set of electromyography (EMG) sensors 128, and a controller 130 via a network 102. The stimulator coupled to the array of electrodes 124, the wearable sensor 126, the set of EMG sensors 128, and the controller 130 are associated with user 112a as represented by lines 132, 134, 136, and 138, respectively.

The array of electrodes 124 may occasionally be referred to herein as an “electrode array,” the “array,” “leads,” “contacts,” or similar. The array of electrodes 124 comprises a plurality of electrodes. The array of electrodes 124 may include a plurality of stimulating elements configured to provide electrical stimulation to a desired target area or record electrical activity from a desired target area. The desired target area may be proximate to one or more of the electrodes comprising the array of electrodes 124. In some implementations, the stimulating elements are also recording elements configured to record electrical activity or electrical signals from a desired area. In some implementations, array of electrodes 124 may include both stimulating elements to provide electrical stimulation to and elements to record electrical signals from a desired area and sensing elements, e.g., configured to detect movement (e.g., flexing and twisting) of the spine. Movement of the spine may be due to flexing, or contracting, of one or more muscles and/or skeletal structures located proximate to the spine of the patient. This movement can be due to voluntary motor control or involuntary motor control.

The array of electrodes 124 may be implanted within the patient 112a such that electrodes are located proximally to the spinal cord of the patient, such as within the epidural space. In some implementations, array of electrodes 124 is implanted within epidural space of the patient proximal to the dorsal root. The array of electrodes 124 may include radiopaque markers or other types of markers or indicators to assist with placement and implantation of the array within the patient 112a. In some implementations, the array of electrodes may be external and apply stimulation transcutaneously.

The exact location of the electrode array 124 implantation may vary depending on the implementation, hardware (e.g., size of the array(s), number of arrays per electrode, electrode placement and/or density in an array, etc.), use case (e.g., for lower-limb or upper-limb), and instance (e.g., variation from patient-to-patient is expected). In some implementations, the target for electrode array 124 implantation is at the midline (i.e., centered relative to the patient’s right and left) of the spinal cord. In some implementations, a stroke may (negatively) affect one side of the patient’s body more than the other, and the target for electrode array 124 implantation may be intentionally implanted off-center. For example, the target for electrode array 124 implantation may be slightly to the right, or left, of the midline to target/emphasize/more directly stimulate, that more stroke-affected side. However, it should be recognized that the actual location is expected to deviate from the targeted position (e.g., midline or biased by a targeted amount to one side) based on a number of factors including, but not limited to one or more of: the surgeon’s skill in implantation, the patient’s physiology, how the patient heals, shifts due to patient movement, etc. In some implementations, an electrode array 124 may include left and right portions (not shown) with left portion implanted on to the left of the midline and the right portion implanted to the right of the midline, to stimulate patient’s the left and right limbs, respectively. In some implementations, the rostral/caudal location varies based on the use case. For example, in some implementations, where the use case relates to upper-limb mobility, the array of electrodes may be implanted in the epidural space of the cervical spinal cord spanning spinal segments from the third cervical vertebra (C3) to the first thoracic vertebra (T1). As another example, in some implementations, where the use case relates to lower-limb mobility, the array of electrodes may be implanted in the lumbar and/or sacral spinal cord.

The number of electrodes in the array of electrodes124 may vary depending on the implementation. For example, the number of electrodes may vary based on the targeted set of limbs (e.g., upper, lower, or both) in the use case, the number of array segments and degree of overlap, the inter-electrode spacing in a linear array of electrodes, etc.

In some implementations, the electrodes comprising the array of electrodes 124 are implanted in specified locations relative to the patient’s anatomy. For example, a first electrode in the array of electrodes 124 is implanted proximal to the dorsal root entry zone of spinal segment C3, a second electrode is implanted proximal to the dorsal root entry zone of spinal segment C4, and so forth to cover C3-T1 portion of the cervical spinal cord. In some implementations, the electrodes comprising the array of electrodes 124 have a fixed location relative to one another (e.g., in a linear array) and the array of electrodes 124 is implanted to span a relevant portion of the spine.

Referring now to FIG. 1B, an example of an electrode array 124, which is illustrated as comprising two linear array segments in FIG. 1A, is illustrated in context 100B (i.e., as implanted in the patient 112A) in accordance with some implementations. As illustrated, a first linear electrode array segment, labeled as “Electrode R 124R,” is implanted in the epidural space rostral relative to a second linear electrode array segment, labeled as “Electrode C 128C,” which is implanted in the epidural space caudal relative to the first linear electrode array, hence the “R” and “C” labels. As illustrated, the electrode array 124 (comprising electrodes R 124R and 124 C) span a portion of the spinal cord relevant to limb mobility, which in the illustrated example includes C3-T1 of the cervical spinal cord and associated with upper-limb mobility.

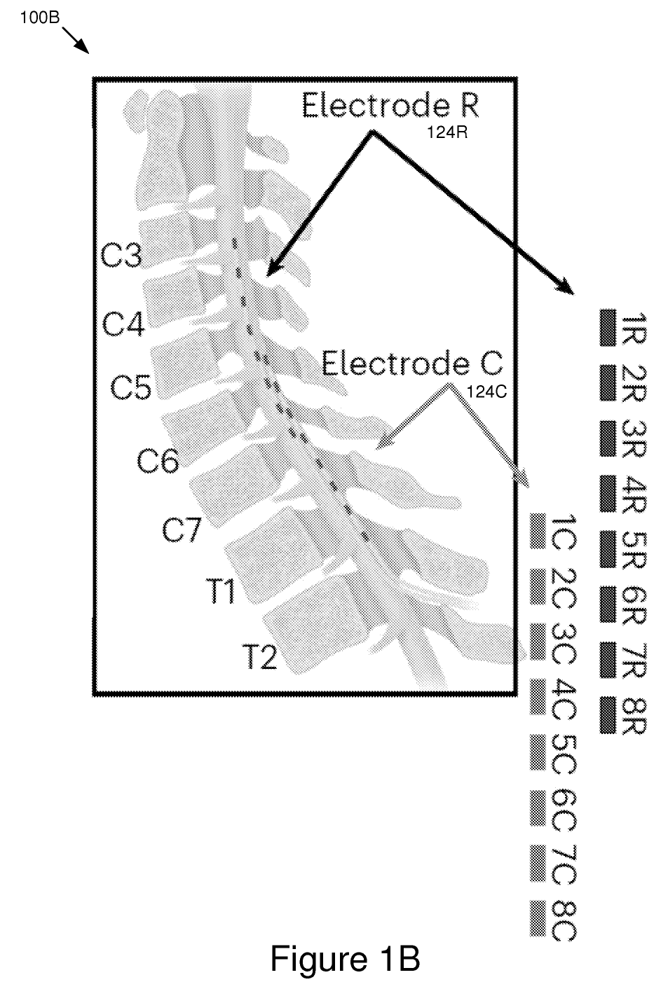

In the illustrated example of FIG. 2B, the electrode array 124 comprises sixteen (16) electrodes, as each electrode array segment 124R and 124C includes eight (8) electrodes. The eight (8) electrodes of electrode R 124R are represented as 1R-8R, and eight (8) electrodes of electrode C 124C are represented as lC-8C.

It should be understood that the electrode arrays 124 illustrated in FIGS. 1A and 1B are merely examples provided for clarity and convenience and that variations are expected and within the scope of this disclosure. For example, while the electrode array 124 is illustrated as comprising two linear array segments (i.e., rostral electrode array R 124R and caudal electrode array C 124 C), the electrode array 124 may comprise more or fewer segments depending on the implementation and/or use case. As another example, the degree of overlap between electrode segments and/or the presence of overlap may vary from what is illustrated in FIG. 1B and depend on the implementation and/or use case. As another example, electrode array segments may be positioned laterally (e.g., right and left of the midline) relative to one another. As another example, the number of electrodes and/or their relative spacing may deviate from the example illustrated in FIG. 1B and depend on the implementation and/or use case. As another example, FIG. 1B is illustrated in the context of the cervical spine, which is relevant to a use case involving upper-limb mobility, but other contexts and use cases (e.g., lumbar and/or sacral spine for a lower-limb use case) are within the scope of this disclosure. As another example, where FIG. 1B represents a desired, or target, implantation of the electrode array 124, some degree of variation from FIG. 1B in actual instances of implantation and/or from patient-to-patient is to be expected, e.g., based on variation in vertebrae size relative to electrode array size and spacing, positioning of the array(s) 124 during implantation and/or shift post-implantation, etc.

In some implementations, an electrode in the array of electrodes 124 may apply electric stimulation at its location. In some implementations, the electric stimulation applied by an electrode in the array of electrodes is associated with a set of parameters. Examples of parameters include, but are not limited to, a current amplitude, a pulse width, a frequency, etc. of a waveform. In some implementations the waveform is a biphasic square wave. However, the waveform may vary depending on the implementation. For example, the waveform may be a sine wave, monophasic pulses, triangle wave, etc. In some implementations, at least one electrode in array 124 is configured to be monopolar where the current delivered through it returns through the case of the stimulator 120. Either the electrode or the case may be the cathode and the other the anode. In some implementations, one or more electrodes are configured to be bipolar or multipolar in that one or more electrodes act as a cathode and one or more other electrodes act as an anode. In some implementations, stimulation is delivered through multiple sets of monopolar or multipolar configurations of electrodes such that stimulation pulses are interleaved in time relative to pulses delivered through other sets of electrodes. In some implementations, each electrode in the electrode array 124 applies either a biphasic and charge-balanced pulse or a monophasic with passive charge balance pulse to ensure no net charge accumulation at the associated electrode. In some implementations, the electric stimulation by a particular electrode (or set of electrodes) in the electrode array 124 and the associated parameters are determined, or applied, by the stimulator 120.

Referring again to FIG. 1A, the stimulator 120 is coupled to the electrode array 124. In some implementations, stimulator 120, which may also be referred to herein as a “neurostimulator,” “neuromodulator,” or similar, is configured to provide electrical signals to electrode array 124 to provide electrical stimulation to a desired area. In some implementations, the stimulator 120 selectively activates, deactivates, and controls the parameters applied at one or more electrodes of the electrode array 124. In some implementations, the stimulator 120 is implanted in the patient 112A (not shown) and powered by a battery (not shown).

In some implementations, the parameters applied by the electrodes (e.g., as part of a kinematic model), are not sufficient, or intended, to induce involuntary motor function. Rather, the stimulation applied by the electrodes modulates the excitability of the motoneurons (where the motoneurons are part of a motor unit used to elicit muscle activity needed to perform a certain movement) so, e.g., the neurological signals for voluntary movement, which may be insufficient absent modulation, are sufficient to reach the corresponding muscles and result in muscle behavior generally consistent with the patient’s intended movement and/or limb behavior.

In some implementations, the one or more parameters are restricted to an associated permissible range. For example, in some implementations, a permissible amplitude range is one or more of a 0-10 mA, 0-25 mA, or a percentage of motor threshold amplitude. In some implementations, the parameters may be restricted to be below a motor threshold, e.g., restricted to a range of 0-20% of motor threshold amplitude or 0-80% of motor threshold amplitude, where the motor threshold amplitude refers to the stimulation amplitude needed to evoke (involuntary) muscle activity as a result of the stimulation itself, as may be the case for kinematic parameters and/or parameters maximizing muscle activation in some implementations. In some implementations, the parameters may be restricted but exceed a motor threshold, e.g., restricted to a range of 0-120% of motor threshold amplitude or 0-180% of motor threshold amplitude, as may be the case for determining the parameters that maximize muscle activation in some implementations. For example, in some implementations, a permissible frequency range may include 0-100 Hz, 0-200 Hz, or 0-10 kHz. For example, in some implementations, a permissible range of pulse frequencies may be 0-400 µS or 0-4 mS. It should be understood that the preceding are merely example ranges and other ranges may be used, e.g., a sub-range within the ranges described above.

In some implementations, the stimulator 120 is communicatively coupled to the server 122 (e.g., via network 102) to receive parameters determined by the neuromodulation determination engine 226 that the stimulator 120 applies at one or more electrodes of the electrode array 124. For example, the stimulator 120 is communicatively coupled to obtain a kinematic model with one or more parameters determined by a neuromodulation LLM trained and/or executed by the neuromodulation determination engine 226.

In some implementations, the stimulator 120 is communicatively coupled to one or more of the controller 130 and the server 122 (e.g., via network 102) to receive one or more kinematic models (described below) that the stimulator 120 applies to control the parameters applied at the electrodes of the electrode array 124.

In some implementations, the stimulator 120 is communicatively coupled to the controller 130 (e.g., via network 102) to receive a user-selected kinematic model (described below) that the stimulator 120 applies to control the parameters applied at one or more electrodes of the electrode array 124.

A wearable sensor 126 is a set of one or more sensors worn by the user 112a. Wearable sensors 126 may be included in one or more form factors including, but not limited to, a smartwatch, a smart ring, chest strap, etc. The wearable sensor 126 may include one or more of a gyroscope, accelerometer, magnetometer, pedometer, heart rate monitor, thermometer, galvanic skin sensor, breathing monitor, oximeter, barometer, etc. In some implementations, the wearable sensor 126 is communicatively coupled to the neuromodulation determination engine 226 to provide wearable sensor data that may provide feedback usable by the neuromodulation LLM (described further below). For example, gyroscope data from a smartwatch may represent a patient’s tremor when reaching, which may be used as feedback by a neuromodulation LLM 236 in addition to, or in lieu of a user’s, response whether a suggest parameter setting achieved the requested outcome (e.g., increased stability when reaching). Also for example, galvanic skin response and/or heart rate and other measurements may detect elevations in physiological stress, which may provide further feedback for the neuromodulation LLM 236.

The EMG sensors 128 are sensors that measure muscle response (e.g., in mV). In some implementations, the EMG sensors 128 are communicatively coupled (e.g., via the network 102) to the neuromodulation determination engine 226.

In some implementations, the EMG sensors 128 are placed on, in, or near the muscles, or muscle groups, associated with the location of the electrode array(s) 124. For example, assume the electrode array 124 is an array of sixteen (16) electrodes arranged in a linear array in the epidural space of the cervical spinal cord spanning spinal segments C3 to T1, which is associated with control of the upper-limbs are located, the EMG sensors 128 may be placed on muscles associated with the upper limbs, such as the biceps, triceps, latissimus dorsi, trapezius, deltoids, pronator teres, flexor carpi radialis longs, palmaris longus, flexor carpi ulnaris, flexor digitorum superficialis, abductor pollicis, brachioradialis, etc. In another example in which the electrode are 124 is arranged in a linear array in the epidural space of the spinal cord spanning spinal segments of the lumbar and/or sacral spinal cord, which is associated with control of the lower-limbs, the EMG sensors 128 may be placed on muscles associated with the lower limbs, such as the glutes, hamstring, quadriceps, tibialis anterior, gastrocnemius, soleus and plantaris, etc.

Other sensors (not shown) may also be included and used without departing from the scope of this disclosure. For example, the system 100 may include a camera (i.e., a sensor) and motion capture software may be used to evaluate a patient’s movement and score the motion (e.g., measure and score how linear a person’s reach) which may may be communicatively coupled (e.g., via the network) to the neuromodulation determination engine 226 and used to train, or evaluate performance of, a model associated with reaching (i.e., an example of a kinematic task) in accordance with some implementations. As another example, the system 100 may include one or more dynamometers (i.e., sensors), which may be used to evaluate grip strength and/or the torque a user can apply at a joint, which may be communicatively coupled (e.g., via the network) to the neuromodulation determination engine 226 and used to train, or evaluate performance of, a model associated with open doors and jar (i.e., an example of a kinematic tasks) in accordance with some implementations.

A controller 130 is a computing device that includes a processor, a memory, and network communication capabilities (e.g., a communication unit). The controller 130 is coupled for electronic communication to the network 102, as illustrated by signal line 148, and may be accessed by a user 112a/x. In some implementations, the controller 130 may send and receive data to and from other entities of the system 100 (e.g., a server 122 and/or stimulator 120). Examples of controllers 130 may include, but are not limited to, mobile phones (e.g., feature phones, smart phones, etc.), tablets, laptops, desktops, netbooks, portable media players, personal digital assistants, or a custom developed piece of hardware, etc.

For simplicity a controller 130 is illustrated in FIG. 1; however, it should be understood that there may be any number of controllers 130. For example, the controller 130 may be used, as illustrated by line 152, by a user 112x that is a programmer or clinician during a configuration and set-up period and subsequently used, as represented by signal line 38, by a user 112a that is a patient, e.g., to switch between kinematic models applied by the stimulator 120 based on the task the patient 112a intends to perform. For example, the patient 112a may select a general model as a default, but when the user intends to carry groceries the patient 112a may select an associated model (e.g., which may maximize the user’s strength but makes a tradeoff, e.g., may sacrifice range of motion in the patient’s elbow). In some implementations, a user (e.g., a patient, programmer, or clinician) may interact with the neuromodulation LLM (not shown) via the controller 130, e.g., to adjust one or more parameters associated with a kinematic model. In some implementations, the controller 130 may include (not shown) an instance of the neuromodulation LLM.

In some implementations, the user 112a and/or 112x is a human user and occasionally referred to based on their role with respect to the system 100, e.g., “patient” or “subject” with regard to user 112a (i.e., the user 112 who has the electrode array 124 and stimulator 120 functionally coupled to his/her nervous system) or “programmer” or “clinician” with regard to user 112x.

The network 102 may be a conventional type, wired and/or wireless, and may have numerous different configurations including a star configuration, token ring configuration, or other configurations. For example, the network 102 may include one or more local area networks (LAN), wide area networks (WAN) (e.g., the Internet), personal area networks (PAN), public networks, private networks, virtual networks, virtual private networks, peer-to-peer networks, near field networks (e.g., Bluetooth®, NFC, etc.), cellular (e.g., 4G or 5G), and/or other interconnected data paths across which multiple devices may communicate.

The server 122 is a computing device that includes a hardware and/or virtual server that includes a processor, a memory, and network communication capabilities (e.g., a communication unit). The server 122 may be communicatively coupled to the network 102, as indicated by signal line 116. In some implementations, the server 122 may send and receive data to and from other entities of the system 100 (e.g., one or more of the controller 130, the sensors 126 and 128, the stimulator 120, etc.).

Other variations and/or combinations are also possible, contemplated, and within the scope of this disclosure. It should be understood that the system 100 illustrated in FIG. 1 is representative of an example system 100 and that a variety of different system environments and configurations are contemplated and are within the scope of the present disclosure. For example, various acts and/or functionality may be moved from one component to another (e.g., from the server 122 to the stimulator 120, from the controller 130 to the server 122, or vice versa), data may be consolidated into a single data store or further segmented into additional data stores, and some implementations may include additional or fewer computing devices, services, and/or networks, and may implement various functionality client-side or server-side. Furthermore, various entities of the system 100 may be integrated into a single computing device or system or divided into additional computing devices or systems, etc. Additional, fewer, or different sensors may be present. The number of electrodes per array, the number of arrays, the amount of overlap (or lack thereof) between two arrays, etc. may vary depending on the implementation. As another example, while only a single server 122 is illustrated, the server 122 may represent a plurality of servers (e.g., a server farm or distributed, cloud environment), and the server 122, in some implementations, may, therefore, include multiple instances (e.g., in different hardware servers, virtual machines, or containers) of the neuromodulation determination engine 226 or portions thereof.

FIG. 2 is a block diagram of an example computing device 200. In the illustrated example, the computing device 200 includes a processor 202, a memory 204, and a communication unit 208. In some implementations, the computing device 200 represents a server 122 and includes an instance of the neuromodulation determination engine 226 and omits an instance of the neuromodulation stimulation engine 228, as illustrated in example of FIG. 1A. In some implementations, the computing device 200 represents a stimulator 120 and includes an instance of the neuromodulation stimulation engine 228 and omits an instance of the neuromodulation determination engine 226, as illustrated in the example of FIG. 1A. In some implementations, the computing device 200 represents a controller 130 and includes an instance of the neuromodulation determination engine 226 and an instance of the neuromodulation stimulation engine 228 or one or more portions thereof. In some implementations, different servers 122 may be associated with training the neuromodulation LLM 236 and executing the neuromodulation LLM 236 to respond to prompts. In some such implementations, the server 122 executing the neuromodulation LLM 236 may include a neuromodulation LLM 236, subject-specific context data 238, and a kinematic model, but may omit the training data 234 LLM base model 232, and the neuromodulation stimulation engine 228.

The processor 202 may execute software instructions by performing various input/output, logical, and/or mathematical operations. The processor 202 may have various computing architectures to process data signals including, for example, a complex instruction set computer (CISC) architecture, a reduced instruction set computer (RISC) architecture, application-specific integrated circuit (ASIC) architecture, field programmable gate array (FPGA) architecture, and/or an architecture implementing a combination of instruction sets. The processor 202 may be physical or virtual and may include a single processing unit or a plurality of processing units or cores. In some implementations, the processor 202 may be capable of generating and providing electronic display signals to a display device, supporting the display of images, capturing and transmitting data, and performing complex tasks and determinations. In some implementations, the processor 202 may be coupled to the memory 204 via the bus 206 to access data and instructions therefrom and store data therein. The bus 206 may couple the processor 202 to the other components of the computing device 200 including, for example, the memory 204, the communication unit 208.

The memory 204 may store and provide access to data for the other components of the computing device 200. The memory 204 may be included in a single computing device or distributed among a plurality of computing devices. In some implementations, the memory 204 may store instructions and/or data that may be executed by the processor 202. The instructions and/or data may include code for performing the techniques described herein or a portion thereof. The memory 204 is also capable of storing other instructions and data, including, for example, an operating system, hardware drivers, other software applications, databases, etc. The memory 204 may be coupled to the bus 206 for communication with the processor 202 and the other components of the computing device 200.

The memory 204 may include one or more non-transitory computer-usable (e.g., readable, writeable) device, a static random access memory (SRAM) device, a dynamic random access memory (DRAM) device, an embedded memory device, a discrete memory device (e.g., a PROM, FPROM, ROM), a hard disk drive, an optical disk drive (CD, DVD, Blu-ray^{TM}, etc.) mediums, which can be any tangible apparatus or device that can contain, store, communicate, or transport instructions, data, computer programs, software, code, routines, etc., for processing by or in connection with the processor 202. In some implementations, the memory 204 may include one or more of volatile memory and non-volatile memory. It should be understood that the memory 204 may be a single device or may include multiple types of devices and configurations.

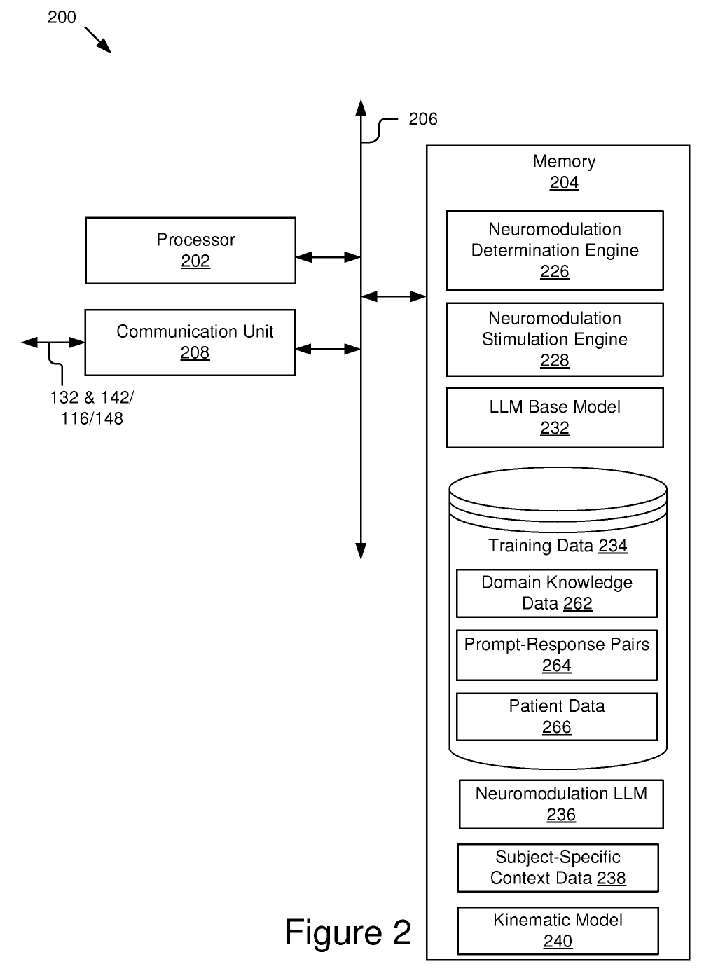

In some implementations, the memory 204 stores one or more of the neuromodulation determination engine 226 and the neuromodulation stimulation engine 228 for execution by the processor 202 to provide the features and functionality described herein. In some implementations, the memory 204 may store one or more of a LLM base model 232, training data 234, a neuromodulation LLM 236, subject-specific context data 238, and a kinematic model 240, which are described below, e.g., with reference to FIGS. 3-5.

It should be understood that, while a single LLM base model 232 is illustrated for clarity and convenience, more than one base model 232 may be present and used and that the multiple base models may differ without departing from the scope of this disclosure. It should be understood that, while a single neuromodulation LLM 236 is illustrated for clarity and convenience, more than one neuromodulation LLM 236 may be present and used without departing from the scope of this disclosure. For example, multiple neuromodulation models associated with different versions of the neuromodulation model and/or may be associated with different hardware, different use cases (e.g., lower vs upper limbs), different stimulation strategies (e.g., a first neuromodulation model 236 instance for mono-polar stimulation and a second neuromodulation model 236 instance for multi-dimensional stimulation), etc. It should be understood that, while a single set of subject-specific context data 238 is illustrated for clarity and convenience; in some implementations, the neuromodulation LLM 236 responds to prompts regarding different subjects/patients and those different subjects/patients have their own associated subject-specific context data 238 specific to that subject/patient, which may be present and used without departing from the scope of this disclosure. It should be understood that, while a single kinematic model 240 is illustrated for clarity and convenience, multiple kinematic may be present and used without departing from the scope of this disclosure. For example, an individual patient may be associated with a set of one or more kinematic models (e.g., each for a different task) specifically for that patient and/or multiple sets of kinematic models associated with a plurality of patients, where each kinematic model is associated with a particular patient, may be stored in the memory 204.

The communication unit 208 is hardware for receiving and transmitting data by linking the processor 202 to the network 102 and other processing systems. The communication unit 208 receives data and transmits the data via the network 102. The communication unit 208 is coupled to the bus 206. In one implementation, the communication unit 208 may include a port for direct physical connection to the network 102 or to another communication channel. For example, the computing device 200 may be the server 122, and the communication unit 208 may include an RJ45 port or other port for wired communication with the network 102 (or directly with one or more other system 100 components). In another implementation, the neuromodulation determination engine 226 and associated functionality is executed by a microprocessor (which may be processor 202 or a another processor (not shown)) inside the stimulator 120 and the communication unit 208 may be an interface included in the microprocessor (such as an analog amplifier, ADC, SPI interface, I2C interface, CAN interface, UART interface, USB interface, TTL interface, or similar) to directly send and receive data to the sensors 126/128 and the stimulator 120. In another implementation, the communication unit 208 may include a wireless transceiver (not shown) for exchanging data via the network 102 or any other communication channel using one or more wireless communication methods, such as IEEE 802.11, IEEE 802.16, Bluetooth® or another suitable wireless communication method.

In yet another implementation, the communication unit 208 may include a cellular communications transceiver for sending and receiving data over a cellular communications network such as via short messaging service (SMS), multimedia messaging service (MMS), hypertext transfer protocol (HTTP), direct data connection, WAP, e-mail or another suitable type of electronic communication. In still another implementation, the communication unit 208 may include a wired port and a wireless transceiver. The communication unit 208 also provides other connections to the network 102 for distribution of files and/or media objects using standard network protocols such as TCP/IP, HTTP, HTTPS, and SMTP as will be understood to those skilled in the art.

It should be apparent to one skilled in the art that the computing device 200 may include other processors, operating systems, inputs (e.g., keyboard, mouse, one or more sensors, microphone, etc.), outputs (e.g., a speaker, display, haptic motor, etc.), and physical configurations without departing from the scope of the disclosure.

Referring now to FIG. 3, a block diagram of an example neuromodulation determination engine 226 is illustrated in accordance with one implementation. As illustrated in FIG. 3, the neuromodulation determination engine 226 may include a neuromodulation large language model (LLM) trainer 302 and a neuromodulation LLM inference engine 304.

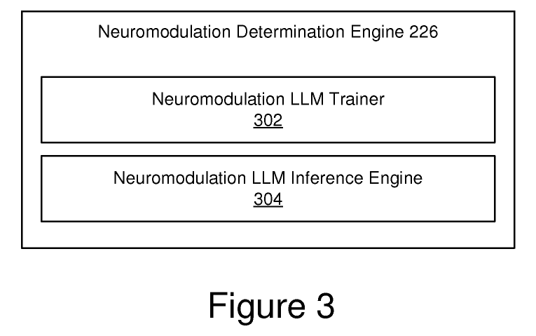

The neuromodulation LLM trainer 302 may include software and/or logic for trains a neuromodulation LLM 236. In some implementations, the neuromodulation LLM trainer 302 obtains and trains a “base,” or “foundational,” large language model (LLM) 232 into a neuromodulation LLM 236 using training data 234. Training of a neuromodulation LLM 236 in accordance with some implementations is described below with reference to FIG. 4 in accordance with some implementations.

The neuromodulation LLM trainer 302 is communicatively coupled to obtain training data 234, a base LLM 232, and to output a trained, neuromodulation LLM 236. For example, the neuromodulation LLM trainer 302, or a portion thereof, may be communicatively coupled to the memory 204 or other data storage (not shown) to obtain an LLM base model 232. As another example, the neuromodulation LLM trainer 302, or a portion thereof, may be communicatively coupled to the memory 204 or other data storage (not shown) to obtain training data 234. As another example, the neuromodulation LLM trainer 302, or a portion thereof, may be communicatively coupled to the memory 204 or other data storage (not shown) to store a neuromodulation LLM 236 subsequent to training of the neuromodulation LLM 236.

Referring now to FIG. 4, a block diagram of an example neuromodulation LLM trainer 302 is illustrated in accordance with some implementations. In the illustrated implementation, the neuromodulation LLM trainer 302 includes a base LLM obtainer 402, a domain data determiner 404, a neuromodulation LLM pre-trainer 406, a neuromodulation LLM tuning engine 408, and a neuromodulation LLM preference optimizer 410.

The base LLM obtainer 402 obtains an LLM as a base model 232, which may also occasionally be referred to herein as a “base model” or a “foundational model.” The LLM base model 232 obtained by the base LLM obtainer 402 may vary depending on the implementation. The variety of LLMs that may be obtained, and subsequently trained, are numerous and defy a complete listing. Examples of LLM models that may be obtained as the LLM base model 332 include, but are not limited to, Meta’s Llama (e.g., 3, 3.1, 3.2, 3.3, etc.), Alibaba’s Qwen (e.g., Qwen2, Qwen 2.5, Qwen3, etc.), Mistral (e.g., Mistral 7B, Mistral Large, Nemo, etc.), Google’s Gemma (e.g., Gemma, Gemma 2, etc.) and Gemini models, Deepseek (e.g. DeepSeek V2, V3, R1, etc.), Bloom, Falcon, DBRX, xAI’s Grok (e.g., Grok-1), AI21 Labs Jamba, Opena AI GPT (e.g., GPT-2, GPT-3, GPT-4, GPT-5, etc.), Bert/RoBERTA, T5/FlanT5, Perplexity’s Sonar, Anthropic’s Claude models (e.g., Claude 3.5 Sonnet, Claude 3 Opus, etc.), Amazon’s Nova (e.g., Nova 2 Lite, etc.), etc.

In some implementations, the base LLM obtainer 402 obtains a base model 232 that is proprietary, or not open source. In some implementations, as described further below, the neuromodulation LLM trainer 302 trains the base LLM 232 into the neuromodulation LLM 236 using patient data, which may be private and/or protected by law. An open source neuromodulation LLM 236 would expose the training data upon which that model is trained, thereby exposing private patient data. Such patient data exposure may be undesirable from a patient privacy perspective and potentially a violation of regulations (e.g., HIPPA, GDPR, etc.). In some implementations, the base LLM 232 and/or resulting neuromodulation LLM 236 are open weight. An open weight model exposes the weightings of the model for transparency and possible modification while protecting patient privacy.

While the description herein may be applied to various base models, one advantage of the description herein (e.g., the training, tuning, and optimization described herein) is that it enables smaller base models to compete with, and perform as well as, much larger base models. For example, the number of parameters in Open AI’s GPT-5 series is not publicly available, but estimates suggest a range of 2-50 trillion parameters. A neuromodulation LLM 236 trained on such a base LLM 232 would therefore have 2-50 trillion parameters and likely require a cloud deployment with extensive resources (e.g., memory and processing capabilities) to train and execute. The (pre)training, tuning, and optimization described herein have been applied to various base LLMs 232 and smaller base models. For example, based on human review and evaluation of responses generated by neuromodulation LLM 236 trained using different base models, using a Llama base LLM having on the order of approximately 12-15 billion parameters produced results comparable to neuromodulation LLM 236 using much larger base LLMs (e.g., multi-trillion parameter LLMs such as GPT-5). Therefore, the (pre)training, tuning, and optimization described herein may reduce resource utilization during training and/or execution of a neuromodulation LLM 236 without sacrificing performance and the smaller neuromodulation LLM 236 create more flexibility in where the neuromodulation LLM 236 may be deployed. For example, a neuromodulation LLM 236 trained using a Llama base LLM having on the order of approximately 12-15 billion parameters, may use approximately 8 Gb of memory, which is rather modest, and may allow that neuromodulation LLM 236 to be stored and executed on a wide variety of devices, e.g., at the stimulator 120 or controller 130.

In some implementations, the base LLM obtainer 402 obtains a base model that is self-hosted. In some implementations, the training of the base LLM model 232 and use of the neuromodulation LLM 236 once trained uses patient data. Using a self-hosted LLM may allow for the training of the base LLM model 232 into the neuromodulation LLM 236 and/or the deployment of the trained neuromodulation LLM 236 to occur on-premises or on institutionally controlled infrastructure, ensuring that protected health information and patient-specific neuromuscular data never leaves that computational environment. Such implementations may ensure, or streamline, regulatory compliance and protect patient privacy.

The base LLM obtainer 402 may be communicatively coupled to one or more other components of the neuromodulation LLM trainer 302. For example, in some implementations, the base LLM obtainer 402 is communicatively coupled to the neuromodulation LLM pre-trainer 406. For example, the base LLM obtainer 402 may send the base model 232 to the neuromodulation LLM pre-trainer 406 or store the base model 232 for retrieval by the neuromodulation LLM pre-trainer 406.

The domain data determiner 404 may include software and/or logic for determining domain knowledge data 262 used as an input by the neuromodulation LLM pre-trainer 406. The domain data determiner 404 is communicatively coupled to obtain domain knowledge data 262, e.g., from memory 204 or another data store (not shown).

In some implementations, the domain knowledge data 262 determined by the domain data determiner 404 includes one or more of: curated scientific and clinical literature related to: neuromuscular rehabilitation, implantable stimulation systems, muscle activation dynamics, and biomechanical motor control; publications and/or technical reports reviewed and processed to extract stimulation strategies, rehabilitation protocols, and observed physiological responses; medical and/or anatomy texts or portions thereof describing the neuromuscular system(s); scientific journals; textbooks; text describing clinical trials, etc.

In some implementations, the domain knowledge data 262 represents one or more of: an understanding of the anatomy of the spinal cord and neuromuscular system(s), an understanding of the physiological effects of changing different stimulation parameters, an understanding of how to probe or test the system in order to make decisions on how electrical stimulation of the spinal cord should be adjusted, safety thresholds, and additional knowledge relevant to spinal cord stimulation, etc.

In some implementations, the domain data determiner 404 maintains a multi-modal database, which may facilitate management of varied data formats (e.g., text, images, video) that may be present in the domain knowledge. For example, a textbook may include anatomical diagrams (i.e., images) in addition to the text, a journal article may include plots or other images. In some implementations, the domain data determiner 404 may generate text-based representations of non-text data. For example, in some implementations, the domain data determiner 404 applies LaTeX to represent non-text in the domain knowledge as text. Since LLMs are generally made to use natural language by default, a textual representation rather than, e.g., an image or video representation, is a preferrable format.

In some implementations, the domain data determiner 404 obtains domain knowledge data and generates embeddings. For example, the domain data determiner 404 obtains a journal article and generates a vector embedding representing that journal article. In some implementations, such vector embeddings may be utilized by subsequently used by the neuromodulation LLM 236 for retrieval augmented generation (RAG). For example, the neuromodulation LLM 236 generates a vector based on a prompt and identifies the most similar vector(s) in the domain knowledge data, and utilizes that set of most similar domain knowledge to formulate a response to the prompt.

The domain data determiner 404 may be communicatively coupled to one or more other components of the neuromodulation LLM trainer 302. For example, in some implementations, the domain data determiner 404 is communicatively coupled to the neuromodulation LLM pre-trainer 406. For example, the domain data determiner 404 may send the domain knowledge data 262 to the neuromodulation LLM pre-trainer 406 or store the domain knowledge data 262 for retrieval by the neuromodulation LLM pre-trainer 406.

The neuromodulation LLM pre-trainer 406 may include software and/or logic for pretraining the base model 232 to adapt the general, base model 232 and prime a resulting, first intermediate LLM (not shown) with domain knowledge represented by the domain knowledge data 262.

The details of the pre-training may vary based on the LLM base model 232. Given the variety of potential LLM base models 232, such as those identified above, a detailed description of the pretraining of each potential LLM base models 232 is impractical. However, a person having ordinary skill in the art would understand that pretrain a variety of LLM base models including, but not limited to those identified herein, using the domain knowledge data 262 is within the scope of this disclosure.

The neuromodulation LLM pre-trainer 406 may be communicatively coupled to one or more other components of the neuromodulation LLM trainer 302. For example, in some implementations, the neuromodulation LLM pre-trainer 406 is communicatively coupled to the neuromodulation LLM tuning engine 408. For example, the neuromodulation LLM pre-trainer 406 may send the first intermediate LLM to the neuromodulation LLM tuning engine 408 or store the first intermediate LLM for retrieval by the neuromodulation LLM tuning engine 408.

It should be understood that while FIG. 4 illustrates the neuromodulation LLM tuning engine 408 and the neuromodulation LLM preference optimizer 410 as distinct boxes within the neuromodulation LLM trainer 302 and are described below as separate processes, in some implementations, tuning and preference optimization may not be discrete processes. For example, in some implementations, odds ratio preference optimization (ORPO) may be used by the neuromodulation LLM trainer 302, which may combine supervised fine tuning (SFT), which is an example of tuning, and preference alignment/optimization into a single step.

The neuromodulation LLM tuning engine 408 may include software and/or logic for tuning the first intermediate LLM. Depending on the implementation and use case, the neuromodulation LLM tuning engine 408 may apply different tuning approaches. Examples of tuning approaches that may be applied by the neuromodulation LLM tuning engine 408 include, but are not necessarily limited to, supervised fine-tuning (SFT), full fine-tuning, parameter-efficient fine-tuning (PEFT), etc.

In some implementations, the neuromodulation LLM tuning engine 408 uses PEFT tuning, which freezes most of the pre-trained model (aka first, intermediary model) and trains a subset of those or additional layers. Examples of PEFT include, but are not necessarily limited to, low-rank adaptation (LoRA), quantized LoRA (QLoRA), prefix-tuning/prompt-tuning, adapters, P-tuning, selective fine-tuning, etc. For example, assume that the first intermediary LLM (the base LLM 232 post pre-training on the domain knowledge data 262) is approximately 100 billion parameters; in some implementations, those 100 billion parameters are frozen and LoRA is applied to train one or more additional layers.

In some implementations, the neuromodulation LLM tuning engine 408 performs tuning based on prompt-response pairs. In some implementations, the prompt-response pairs include an initial set of prompt-response pairs based on the domain knowledge data 262. For example, in some implementations, publications and technical reports within the domain knowledge data 262 were reviewed and processed to extract stimulation strategies, rehabilitation protocols, and observed physiological responses. This information was transformed into structured prompts that represent clinically meaningful questions and decision scenarios as well as appropriate responses. For example, assume that domain knowledge data (e.g., an anatomy textbook) indicates that the bicep brachii nerves that control the bicep are typically located near the C5 vertebra, and that the clinical trial or protocol data indicates that this is where the where the 5R electrode in the rostral electrode array 124R is implanted from FIG. 1B is located; in some implementations, a prompt such as “Which electrode stimulates the bicep” may be paired with a response such as “5R,” with the response “the electrode closest to the C5 vertebra,” or both (e.g., in different prompt-response pairs). As another example, assume that domain knowledge data (e.g., protocol) indicates that increasing current amplitude near the C5 vertebra increases bicep activation; in some implementations, a prompt such as “How do I increase bicep activation” may be paired with a response such as “increase the current amplitude at electrode 5R,” with the response “increase the current at the electrode closest to the C5 vertebra,” or both (e.g., in different prompt-response pairs).

Depending on the implementation, the number of prompt-response pairs may vary. For example, various tunings with prompt-response pairs ranging of approximately one-thousand to three-thousand prompt-response pairs are used in various implementations. However, other numbers of prompt-response pairs (within or outside that range) may be used without departing from the scope of this description.

In some implementations, the prompt-response pairs may include a set of machine generated prompt-response pairs extracted from the domain knowledge data 262, e.g., via machine learning such as an LLM (not shown). For example, an LLM (not shown) is applied to an anatomy textbook to extract the C5 vertebra as a locus response to a question regarding where to apply stimulus to activate the bicep.

In some implementations, the prompt-response pairs may include a set of expertly curated prompt-response pairs. The expertly curated prompt-response pairs include human-generated prompt-response pairs represent realistic decision-making situations encountered when adjusting stimulation parameters or interpreting muscle activation responses in patients with implanted neuromodulation devices. The associated responses encode (human) expert-level reasoning about stimulation strategies, including expected muscle activation patterns, functional outcomes, and safety considerations, how changing parameters such as amplitude, frequency, or pulse width of the stimulation waveform affects the motor outcome of stimulation, etc.

In some implementations, the prompt-response pairs may include one or more clinical prompt-response pairs. For example, a patient’s requests and a human clinician’s response (e.g., representing which parameter, on which electrode, was changed, in which direction, by what degree, to what value, etc.) in a clinical session may be used to generate a prompt-response pair.

In some implementations, the prompt-response pairs may include one or more prompt-response pairs generated by execution of a prior version of the neuromodulation LLM 236. For example, assume a neuromodulation LLM 236 is put into production and provides suggested parameter settings (responses) and those responses may be paired with their associated requests (prompts), thereby generating prompt-response pairs, which may be used to train (or tune) subsequent versions of the neuromodulation LLM 236.

In some implementations, a prompt-response pair may be associated with a weighting or otherwise encode whether the response was good (e.g., factually correct or resulted in better performance/decreased impairment) or not. In some implementations, the encoding of whether a response to a user prompt was helpful or correct may be used to tune subsequent versions of the neuromodulation LLM 236.

In some implementations, a prompt-response pair may be normalized based on subject-specific context data or other information about the patient/subject. For example, rather than a final current amplitude or a number of mA suggested in the original response (e.g., by a clinician or prior version of the neuromodulation LLM 236); in some implementations, the response may be normalized (e.g., to a direction of adjustment and percentage of adjustment). In some implementations, a prompt-response pair may be associated with subject-specific context data or otherwise encode information about the patient/subject (e.g., a parameter setting before and/or after, information about the patient’s relative impairment, relative electrode array 124 placement, response data, etc.) to put the response whether the result was “good” or “bad” into the context of that specific patient.

In some implementations, a neuromodulation LLM 236 trained and/or tuned on a set of prompt-response pairs, may provide responses that are non-intuitive to, or beyond what a human programmer would come up with, and those may be encoded into subsequent versions of the neuromodulation LLM 236. For example, it should be understood that a human clinician does not mentally retain a final parameter setting, much less mentally retain, process, and extract meaning from intermediary adjustments he/she made in a single clinician session with a single patient, much less across various patients with their different circumstances. The intermediary adjustments, which are discarded data points in a human implemented guess-and-check method but may be leveraged and the neuromodulation LLM 236 may provide responses based on new and/or non-intuitive insights.

A “second, intermediary LLM” is occasionally used herein to refer to the LLM after pre-training and post-tuning but prior to preference optimization. The neuromodulation LLM tuning engine 408 may be communicatively coupled to one or more other components of the neuromodulation LLM trainer 302. For example, in some implementations, the neuromodulation LLM tuning engine 408 is communicatively coupled to the neuromodulation LLM tuning engine 408. For example, the neuromodulation LLM tuning engine 408 may send the second, intermediary LLM to the neuromodulation LLM preference optimizer 410 or store the second, intermediary model for retrieval by the neuromodulation LLM preference optimizer 410.

The neuromodulation LLM preference optimizer 410 may include software and/or logic for performing preference optimization. Preference optimization may ensure that the neuromodulation LLM 236 outputs align with human preferences (e.g., in style, format, etc.). The preference optimization applied by the neuromodulation LLM preference optimizer 410 may vary depending on the implementation. Examples of optimization include, but are not necessarily limited to, reinforcement learning from human feedback (RLHF), direct preference optimization (DPO), proximal policy optimization (PPO), odds ratio preference optimization (ORPO), etc.

In some implementations, the neuromodulation LLM preference optimizer 410 outputs the neuromodulation LLM 236 upon completion of the preference optimization.

The neuromodulation LLM preference optimizer 410 may be communicatively coupled to other components or subcomponents of the neuromodulation determination engine 226. For example, in some implementations, the neuromodulation LLM preference optimizer 410 is communicatively coupled to the neuromodulation LLM inference engine 304. For example, the neuromodulation LLM preference optimizer 410 may send the neuromodulation LLM 236 to the neuromodulation LLM inference engine 304 or store the neuromodulation LLM 236 for retrieval by the neuromodulation LLM inference engine 304.

Referring again to FIG. 3, in some implementations, the neuromodulation LLM inference engine may include software and/or logic for executing the neuromodulation LLM 236. For example, the neuromodulation LLM inference engine 304 receives inputs from one or more users 112a/x, which may occasionally be referred to herein as “prompts” or “queries,” applies the neuromodulation LLM 236, and sends one or more outputs, which may occasionally be referred to herein as “responses,” to the one or more users responsive to a respective input/prompt.

In some implementations, the neuromodulation LLM inference engine 304 receives a prompt associated with a particular patient/subject. In some implementations, the particular patient may, or may not, be explicitly identified in a prompt depending on the use case and implementation. For example, in some implementations and use cases the prompt may include a “for patient number N,” where N is a patient identifier, to explicitly identify the particular patient associated with the prompt. As another example, the particular patient may be identified contextually. For example, the patient was identified previously (e.g., by one or more of via prior login or identification via the controller 130), based on proximity to, or presence of, that patient’s stimulator 120, etc.

In some implementations, the neuromodulation LLM inference engine 304 obtains the subject-specific context data 238 associated with the particular patient determined to be associated with the prompt. By obtaining the subject-specific context data 238 for that patient, the output of the neuromodulation LLM inference engine 304 (or neuromodulation LLM 236) may be personalized to that particular patient. In some implementations, the neuromodulation LLM inference engine 304 obtains the subject-specific context data 238 may be included in the prompt. In other implementations, the neuromodulation LLM inference engine 304 determines and obtains the subject-specific context data 238. For example, the neuromodulation LLM inference engine 304 uses retrieval-augmented generation (RAG) framework to obtain the subject-specific context data 238 associated with the particular patient associated with the prompt and input that subject-specific context data 238 (or a portion thereof) as an input (in addition to the prompt) into the neuromodulation LLM 236.

The subject-specific context data 238 may vary depending on the implementation and use case. In some implementations, the subject-specific context data 238 includes one or more of a neuromuscular mapping (not shown), a kinematic model, and a patient history (not shown).

In some implementations, the subject-specific context data 238 includes a neuromuscular mapping associated with the particular patient. The neuromuscular map describes the patient’s response to an initial set of test parameters. In some implementations, the initial set of test parameters may have been applied to the patient post-implantation of the electrode arrays 124 and that patient’s response to initial set of test parameters may have been measured via EMG sensors 128 (e.g., while that patient was still under anesthesia).

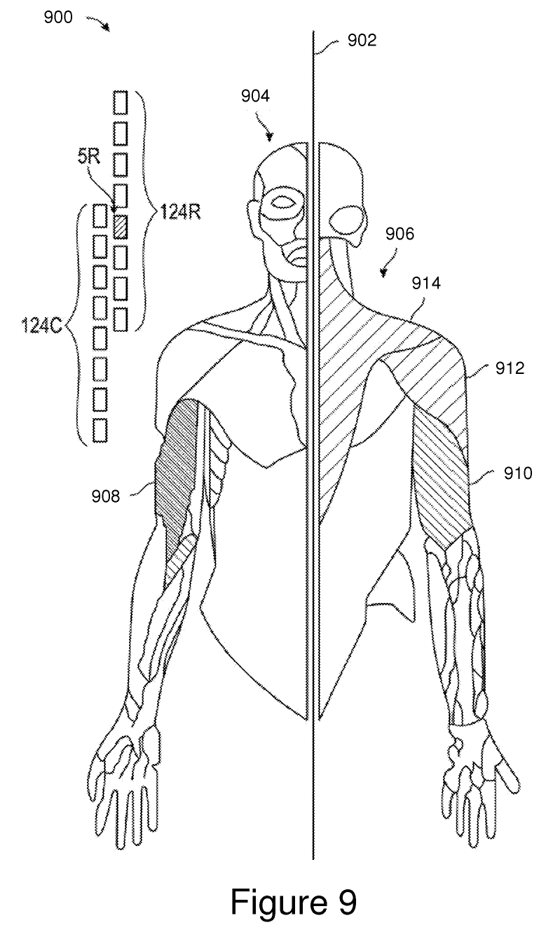

Referring now to FIG. 9, an example illustration representing a neuromuscular mapping, or portion thereof, in accordance with some implementations is shown. In the illustrated implementation, an EMG sensor 128 is associated with each of the muscles, or muscle groups, identified in the color code legend 802. For example, a first EMG sensor 128 is applied to the subject’s right trapezius, a second EMG sensor 128 is applied to the subject’s right, anterior deltoid, a third EMG sensor 128 is applied to the subject’s right middle deltoid, a fourth EMG sensor 128 is applied to the subject’s right posterior deltoid, a fifth EMG sensor 128 is applied to the subject’s right bicep, a sixth EMG sensor 128 is applied to the subject’s right triceps, a seventh EMG sensor 128 is applied to the subject’s right forearm extensor muscle(s), an eighth EMG sensor 128 is applied to the subject’s right forearm flexor muscle(s), a ninth EMG sensor 128 is applied to the subject’s right pronator muscle, a tenth EMG sensor 128 is applied to the subject’s right abductor pollicis brevis (APB), and an eleventh EMG sensor 128 is applied to the subject’s right abductor digiti minimi (ADM). In some implementations, after implantation of the electrode array 124 in the subject, electrical stimulus (i.e., an initial set of test parameters) is applied via the electrode array 124 and the patient’s response is recorded. In some implementations, the patient’s response to this stimulus may be included in the neuromuscular mapping associated with that patient, which may be included in the subject-specific context data 238 associated with that patient.

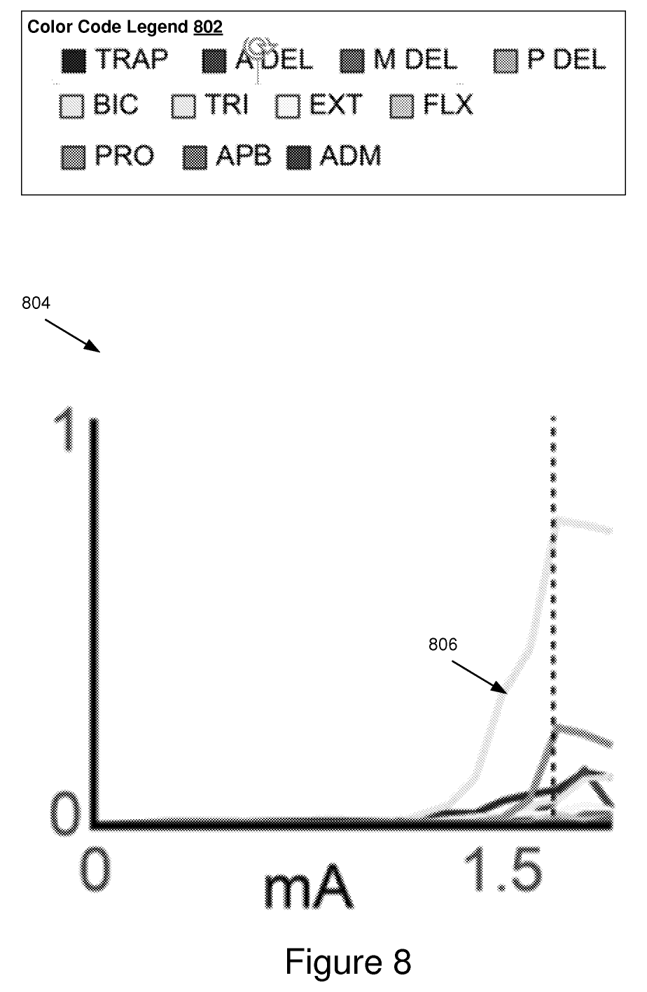

For example, still referring to FIG. 8, a plot of the degree of muscle activation (e.g., mV (amplitude) recorded by an EMG sensor 128 or mV normalized to an amplitude scale ranging from 0-to-1) responsive to a mono-polar stimulus applied at electrode 5R is represented by the y-axis and the current amplitude of that stimulus (e.g., in mA) is represented by the x-axis. Line 806 represents the biceps response, e.g., as measured by the “fifth EMG sensor 128” in the above example. Plot 804 indicates that in this example, stimulus at electrode 5R activates the right bicep and the activation is selective, as represented by how tall the peak of line 806 is compared to those of the lines representing the activation, as measured by EMG sensor 128 data, of the other arm muscles. The patient’s muscle activation response represented by plot 804 may also be visualized anatomically, e.g., in the example illustrated at FIG. 9.

Referring now to FIG. 9, an illustration 900 of the muscles activated by electrode 5R is illustrated in accordance with some implementations. In FIG. 9, a diagram of the electrode arrays 124R and 124C as implanted in FIG. 1B are illustrated by the lines of blocks labeled at 124 R and 124C, respectively. Electrode 5R is shaded to indicate mono-polar stimulation at electrode 5R. To the left of the bisection line 902, a representation 904 of at least a portion of the human musculature visible, when viewing the front of a human body, is illustrated, particularly those muscles association with upper-limb mobility. To the right of the bisection line 902, a representation 906 of at least a portion of the human musculature visible, when viewing the back of a human body, is illustrated, particularly those muscles association with upper-limb mobility. The shading indicates which muscles are activated and the relative degree of activation, where the darker the shading; the greater the stimulation (e.g., as measured by resulting EMG data). As illustrated in the example, a mono-polar stimulation at electrode 5R induces more stimulation to the bicep 908 relative to other arm muscles including the triceps 910, deltoids 912, and trapezius muscles 914, which are also stimulated in accordance with some implementations and use cases.

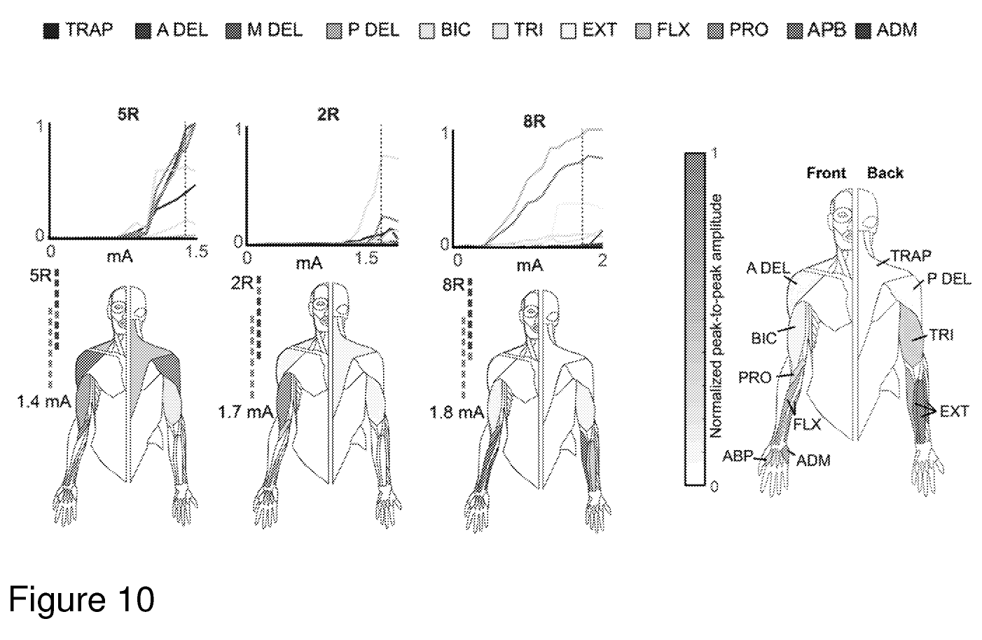

While FIG. 8 and 9 describe neuromuscular mapping in the context of a mono-polar stimulation at electrode 5R and response as measured at the subject’s right arm. It should be recognized that this is merely a subset of the neuromuscular mapping in some implementations. For example, in some implementations, the neuromuscular mapping may represent the subject’s response at both limbs (e.g., both upper limbs or both lower limbs). As another example, in some implementations, the neuromuscular mapping may represent the subject’s response to monopolar stimulation at each of the electrodes in the electrode array 124. For example, referring now to FIG. 10, plots for mono-polar stimulation at electrodes 5R, 2R and 8R are illustrated and others (not shown) may be included in the neuromuscular mapping for a patient. It should be understood that, while electrode 5R selectively activated the bicep of the patient described with reference to FIGS. 8 and 9, electrode 2R selectively activates the bicep of the patient described with reference to FIG. 10, e.g., due differences in how the electrode arrays are positioned in their respective patients and that the systems and methods described herein may account for such variations between implantations.

In some implementations, the neuromodulation LLM inference engine 304 determines a set of electrical parameters including their values and associated electrode(s) that reduce motor impairment, e.g., facilitate performance of one or more kinematic tasks. A set of electrical parameters including their values and associated electrode(s) that facilitate performance of one or more kinematic tasks may be referred to as a “kinematic model,” a “kinematic parameter set,” or similar.

In some implementations, the neuromodulation LLM inference engine 304, or at least a portion thereof, may determine more than one kinematic model, which may be selected and applied to the patient. For example, a default or general model may be determined by the neuromodulation LLM inference engine 304, or at least a portion thereof and applied by the stimulator 120 for general tasks, and the patient 112a may select a more specialized kinematic model determined by the neuromodulation LLM inference engine 304, or at least a portion thereof, and applied by the stimulator 120 when the patient 112a intends to perform the associated task.

In some implementations, the subject-specific context data 238 includes a kinematic model. For example, in some implementations, a kinematic model 240, which is illustrated outside of the subject-specific context data 238 in FIG. 2, is included in the subject-specific context data 238.

In some implementations, the subject-specific context data 238 may include a set of kinematic models (not shown) for various tasks and the associated parameters for that particular patient for each respective task. For example, in some implementations, the subject-specific context data 238 may include a reaching kinematic model, which the user may intend to refine as indicated by a prompt, and the neuromodulation LLM inference engine 304 obtains subject-specific context data 238 including that kinematic model for reaching.

In some implementations, the subject-specific context data 238 includes a patient history (not shown). That patient history may represent one or more of: the parameter(s) the neuromodulation LLM 236 suggested to modify, the direction of modification, the degree of modification, the value of the suggested parameter post modification, whether the suggested modification was an improvement, etc. In some implementations, as a user interacts with the neuromodulation LLM 236 via the neuromodulation LLM inference engine 304 encodes the interactions and results to inform future responses to future prompts. For example, in some implementations, as a user interacts with the neuromodulation LLM 236 via the neuromodulation LLM inference engine 304 generates specific prompt-response pairs for that particular subject and store the subject-specific prompt response pairs (and perhaps a label indicating whether the response represented an improvement) in a patient history included in the subject-specific context data 238.

In some implementations, the patient history encoded into the subject-specific context data 238 may allow the neuromodulation LLM 236 to provide more accurate responses (e.g., suggested parameter(s) that improve performance of a task or address an issue identified by the prompt) by taking into account prior outputs to that user and whether those outputs represent success and failure (e.g., parameters associated with improvement or worsening, respectively) for that particular user.

It should be understood that even the most skilled operators may not be able to keep all data collected over the course of using the stimulator 120 in-mind when making manual decisions about how to adjust stimulation. Going through large data sets of physiological testing, kinematic evaluations, patient inputs, and historical setting adjustments (that may have happened months or years prior), and much more, would be an impossible task for a human, and it ultimately limits the complexity of stimulation patterns that can be identified by a human operator and wastes time as the operator may re-attempt previously unsuccessful parameters or strategies. By contrast, a neuromodulation LLM 236 may learn over the lifetime of the patient’s use to understand which changes had the best outcomes in the past, and how stimulation might be modified, or applied, in the present to get a desired result.

In some implementations, the patient history encoded into the subject-specific context data 238 for various patients may be omitted from (re)training of the neuromodulation LLM 236. In some implementations, the patient history encoded into the subject-specific context data 238 (e.g., as prompt-response pairs) may be used in (re)training of the neuromodulation LLM 236.

In some implementations, the neuromodulation LLM inference engine 304 is communicatively coupled to obtain a neuromodulation LLM 236, receive user prompts, obtain a querying patient’s data 238, and output responses. For example, the neuromodulation LLM inference engine 304 may be communicatively coupled to the memory 204 or other data storage (not shown) to obtain the neuromodulation LLM 236. As another example, the neuromodulation LLM inference engine 304 may be communicatively coupled to the memory 204 or other data storage (not shown) to obtain a subject-specific context data 238 associated with the patient/subject that is associated with, or identified in, the prompt. As another example, the neuromodulation LLM inference engine 304 may be communicatively coupled to the controller 130, the memory 204, or other data storage (not shown), to obtain a prompt and/or present, or store for presentation, an output to a user.

In some implementations, a user 112a/x may interact with the neuromodulation LLM 236 (e.g., via the neuromodulation LLM inference engine 304 and an interface presented to the user 112a/x) to provide prompts to the neuromodulation LLM 236 and obtain responses from the neuromodulation LLM 236. In some implementations, the response(s) from the neuromodulation LLM 236 may include a set of one or more suggested parameters that are to be applied by the neuromodulation stimulation engine 228, e.g., as part of a kinematic model 240. For example, assume that the user 112a/x provides a prompt asking for greater elbow stability while reaching for a particular patient; in some implementations, the neuromodulation LLM 236 may obtain the prompt and, responsive to the prompt, obtain the subject-specific context data 238 for that particular patient, and output a set of one or more electrical parameters that modify the current set of electrical parameters associated with a reaching kinematic model.

In some implementations, the user 112a/x may converse (e.g., iteratively via audio/voice and/or via text) using a user interface (not shown) with the neuromodulation LLM 236 as to whether the patient perceived increased elbow stability, or not, and the user and neuromodulation LLM 236 may continue to interact and iterate, e.g., through a series of prompts and responses to determine one or more electrical parameters associated with one or more kinematic models, to refine and customize those kinematic models for that particular patient. In some implementations, a particular kinematic model may be customized, via interaction with the neuromodulation LLM 236, for the patient’s particular physiology, electrode placement, deficits, and for a patient’s individual preference. For example, a first patient may place greater relative value on stability while reaching than a second patient who may place greater relative value on maximizing the distance he/she can reach when reaching, or than a third patient who may place greater relative value on the linearity of the reaching motion (i.e., minimizing or reducing path distance traveled), thus the three patients may each interact with the neuromodulation LLM 236 via the neuromodulation LLM inference engine 304 to obtain one or more parameters to customize/modify their respective “reaching” kinematic models to materialize those preferences in their respective reaching kinematic models and physical reaching.

In some implementations, an output of the neuromodulation LLM inference engine 304 (or neuromodulation LLM 236 thereof) may be automatically applied. For example, a new kinematic model 240 may be generated as an output and/or automatically applied by the stimulator 120, one or more updated/modified parameters and/or electrodes for stimulation may be output and an associated kinematic model 240 may be automatically updated and/or automatically applied by the stimulator 120.

In some implementations, a human remains in the loop between an output of the neuromodulation LLM inference engine 304 (or neuromodulation LLM 236 thereof) and application to a patient. For example, a human programmer 112x may vet the output to ensure one or more of a suggested parameter does not exceed a safety threshold and does not exceed hardware capabilities. As another example, a human programmer 112x may vet the output by inputting that output into a simulation environment (not shown) to evaluate whether the output is likely to achieve the desired result.

It should be understood that even in implementations that maintain a human programmer 112x in the loop, the output of the neuromodulation LLM inference engine 304 (or neuromodulation LLM 236 thereof may not have been made by a “standard” human programmer 112x. For example, the output may have been akin to that of a highly trained programmer, thereby improving results in human-implemented implementations and reducing the expertise needed and learning curve for effectively programming the stimulator 120, or the output may not have been made at all by a programmer, as the output may be based on the neuromodulation LLM inference engine 304 (or neuromodulation LLM 236 thereof) having an understanding of complex multi-dimensional interactions the human mind would not, or could not, extract from patient data. As another example, a human programmer 112x may increase current amplitude on an electrode to increase recruitment of a particular muscle (e.g., on electrode 5R to increase recruitment of the bicep as illustrated in FIG. 8 and 9). However, as more and more current is delivered, the higher current is generally less selective and, e.g., the subject may begin to see increased activation in the triceps. A human programmer 112x may therefore set the current parameter below the point where the stimulation becomes less selective, and begin increasing the frequency of the stimulation to increase bicep activation without increasing the volume of muscle tissue activated, which may be related to the current amplitude. Increasing frequency may increase the activation to a point. However, at some point high frequencies suppress muscle activation. What constitutes “high” may vary from patient-to-patient and the intricacies of this synaptic suppression are not fully understood. However, a human programmer 112x may progressively increase the frequency applied at 5R to increase recruitment of the bicep to the point that synaptic suppression begins to manifest and back off the frequency off to a setting prior to occurrence of the synaptic suppression. The neuromodulation LLM inference engine 304 (or neuromodulation LLM 236 thereof) may learn about and leverage synaptic suppression to greater therapeutic effect. For example, a neuromodulation LLM inference engine 304 (or neuromodulation LLM 236 thereof) may use a current amplitude at 5R that in isolation would no longer selectively activate only the bicep (thereby exceeding what a human programmer 112x would use) and recruits other muscles, but then apply a high frequency stimulus at another electrode that selectively stimulates those other muscles to induce synaptic suppression, thereby achieving greater selective activation of the bicep.

To better understand some of the features and benefits of the neuromodulation LLM tuning engine 408 and the neuromodulation LLM 236 it may be beneficial to understand and contrast to the human-implemented trial-and-error process. In the human-implemented trial-and-error process, a programmer or clinician would select an electrode, input a set of parameters for that electrode, observes the muscle responses (e.g., represented in EMG 128 sensor data) to determine which muscle(s) were activated and to what degree, then selects a new electrode and/or new parameters, repeat the trial-and-error until the programmer is satisfied that he/she has found the set of parameters that maximize a specific muscle (e.g. the biceps). The programmer then moves to the next muscle or muscle group (e.g., triceps) and repeats the process to determine which singular electrode and set of parameters maximize the activation of that next muscle or muscle group (e.g. triceps).

It should be understood that the human-implemented guess-and-check process is time consuming as the parameter space to be explored is large (e.g., the number of available electrodes in the array 124 times number of available amplitudes times number of available frequencies times number of available pulse widths, etc.). Additionally, that time is multiplied by the number of muscles or muscle groups of interest in the limb, as the human-implemented process is performed serially for each of the multiple muscles or muscle groups of interest that are associated with a limb. Furthermore, the human-implemented process often uses one electrode at a time and ignores the potential to use multiple electrodes simultaneously to achieve improved stimulation, as the multi-dimensional interactions may become too complex and non-intuitive/unpredictable for a human clinician to explore and optimize. Over time a human clinician may develop a better understanding of the parameter space in general and obtain some modest performance gains, but the number of iterations will generally remain high and be time consuming. The variation in the time to outcome and the overall outcome for a patient being dependent upon the availability, skill, and potentially luck of the programmer (e.g., moving to a global maximized activation rather than a local maximum is sub-optimal and possible). The time-consuming nature increases costs and inconvenience to the patient. Moreover, it may subject the patient to additional risks.

Furthermore, the types of limb movement needed to perform a task, where “task” may also be referred to herein as a “kinematic task,” “target kinematic task,” “motor outcome,” “physiological function,” “intended task,” “desired task,” or similar, may involve more than a singular muscle (e.g., more than the just the bicep). For example, it is not uncommon for a kinematic task to require use and/or orchestration of multiple muscles and/or groups of muscles for successful completion. Those multiple muscles (or groups) may include two or more muscles in opposition, such as the triceps and biceps for the extension-flexion involved in a reaching task. Therefore, once parameters that maximize activation of a particular muscle or group of muscles (in absolute or selective terms) is identified, the human-implemented guess-and-check process requires additional, time-consuming guess-and-check to balance and iterate through parameter settings that orchestrate and balance activation of the opposing muscles to perform a task (e.g., the biceps and triceps in a reaching task).

Additionally, tasks that involve multiple muscles may be activated by stimulation at different electrodes or sets of electrodes, thus the kinematic model 240 is frequently multi-dimensional, where multiple different electrodes in the array are each applying different parameter values and which may interact (e.g., through constructive and/or destructive interference). The number of multi-dimensional combinations may itself be quite large and when compounded by the number of parameters and possible parameter values (even if discretized), the parameter space for the kinematic model is large. The human-implemented guess-and-check process relies on trial-and-error and the human clinician (or the human mind) is ill-suited and does not extract patterns from the complex interactions in multi-dimensional stimulation. For example, a human clinician will not develop an understanding of how to leverage constructive and/or destructive interference between various (e.g., non-intuitive) electrodes to improve outcomes or achieve different desirable results and/or avoid undesirable results.

The neuromodulation LLM inference engine 304 is communicatively coupled to obtain a kinematic model 240 from one or more of the stimulator 120 and the controller 130. For example, the neuromodulation LLM inference engine 304 may be communicatively coupled to the memory 204, and one or more of the stimulator 120 and the controller 130 may retrieve (e.g., via network 102) one or more kinematic models therefrom. As another example, the neuromodulation LLM inference engine 304 may be communicatively coupled to one or more of the stimulator 120 and the controller 130 and send one or more kinematic models thereto.

In some implementations, the neuromodulation LLM inference engine 304 identifies (e.g., using the neuromodulation LLM 326) a target kinematic task. Examples of target tasks related to upper-limb mobility may include, but are not limited to reaching, griping, lifting, throwing, etc. Examples of target tasks related to lower-limb mobility may include, but are not limited to squatting, kicking, climbing stairs, walking, jumping, etc. Examples of general target tasks may include, but are not limited to maximizing a range of motion for one or more joints of interest, maximizing a torque production at one or more joints of interest, maximizing the co-activation of muscles involved in certain synergies involved in a kinematic task of interest, etc.

In some implementations, there may be a “general” task for versatility (e.g., balances factors such as range of motion, strength or torque, linearity of motion, smoothness of motion, etc., which may each be weighted), and the general task model may be used as default kinematic model. In some implementations, the general task kinematic model is a composite derived from, or that combines, a plurality kinematic models associated with other kinematic tasks or a subset thereof (e.g., a subset of the most frequently performed tasks). For example, the general task kinematic model interleaves delivery of the various, associated kinematic models (e.g., reaching kinematic model, picking something up kinematic model, gripping interactive model, etc. then repeats). It should be recognized that the frequency of interleaving, the number of kinematic models interleaved, and their associated tasks may vary based on the implementation and use case. It should also be recognized that other methods of derivation, or combination, are contemplated, and within the scope of this disclosure, such as determining the general kinematic model’s parameter set mathematically from the set of constituent kinematic models.

For clarity and convenience, the description herein makes frequent reference to an example in which the kinematic task is reaching. In some implementations, the identification of the target kinematic task may be based on user input. For example, a user 112x or 112a selects “reaching” from a pre-populated list of suggested tasks or inputs “reaching” (e.g., as part of a prompt). As another example, the user 112x inputs “reaching” as the name of the kinematic model to be determined.

In some implementations, the application of the kinematic model and/or parameter(s) suggested by the neuromodulation LLM 236 may maintain a human-in-the-loop in that human input (e.g., approval via a selection of a graphical element in a UI displayed on the controller 130) may be required for application to the patient. In some implementations, the application of the kinematic model and/or parameter(s) suggested by the neuromodulation LLM 236 may be automatic. In some implementations, the application of the kinematic model and/or parameter(s) suggested by the neuromodulation LLM 236 may be evaluated in a simulation environment (not shown) to determine whether the suggested parameters (e.g. stimulation patterns) produced muscle activation behaviors consistent with the intended therapeutic objectives.

It should be recognized that, when a parameter set associated with a kinematic model is applied the patient 112a via the stimulator 120 and electrode array 124, is one or more of reduced motor impairment in the patient, restored physiological function, and better performance of a task associated with the kinematic model.

The neuromodulation LLM inference engine 304 outputs one or more kinematic parameters or a modification thereto depending on the implementation. The set of kinematic parameters may include a plurality of electrodes and the parameter values applied at each of those electrodes to stimulate the patient’s nervous system (e.g., spinal cord). A complete set of kinematic parameters for a particular task may also occasionally be referred herein to as “a kinematic model.” Depending on the use case, the output of the neuromodulation LLM inference engine 408 may vary. In some implementations and use cases, the output may include an entire kinematic model. For example, a complete set of electrodes and their respective parameters for a “reaching” task. In some implementations and use cases, the output may include only a portion of a kinematic model and/or a modification to kinematic model. For example, the neuromodulation LLM inference engine 408 may output a response suggesting that the current amplitude on electrode X be adjusted to Y to obtain greater elbow stability responsive to a user prompt indicating a desire to increase elbow stability.

In some implementations, the system 100 may create and maintain a library or collection (not shown) of available kinematic models for a particular patient and/or across patients. For example, each kinematic model 240 in such a collection for a particular patient may be associated with a different task. The kinematic model(s) may be sent to the stimulator 120 for application to the patient 112a via the associated electrodes in the electrode array 124. For example, a user 112a/x may select a kinematic model 240 for a desired task and the kinematic model 240 for that patient for that task may be sent to the stimulator 120 and applied to the patient.

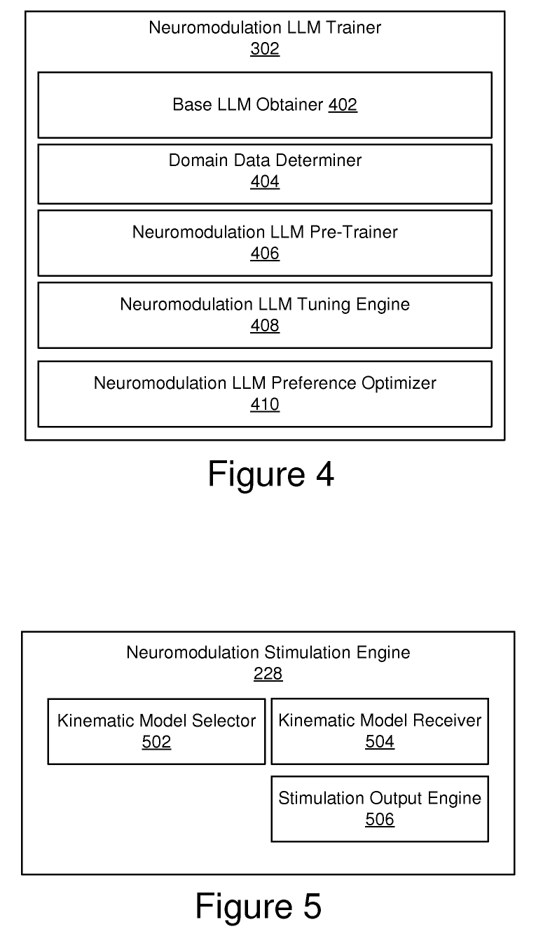

In some implementations, the stimulator 120 includes an instance of the neuromodulation stimulation engine 228. An example box diagram of the neuromodulation stimulation engine 228 is illustrated at FIG. 5 in accordance with some implementations. In the illustrated implementation, the neuromodulation stimulation engine 228 includes a kinematic model selector 502, a kinematic model receiver 504, and a stimulation output engine 506.

In some implementations, multiple kinematic models are each specific to the patient 112a and available to the patient 112a for use. The kinematic model selector 502 may include software and/or logic for at least partially enabling user selection of a desired kinematic model 240 or associated task. For example, in some implementations, the controller 130 (e.g., tablet, laptop, smart phone, etc.) may present a user interface to the user with multiple portions each associated with a kinematic model 240 for different tasks, and the patient 112a (or other user) may select the task/kinematic model 240 to be applied by the stimulator 120 and switch between kinematic models/tasks and the stimulator 120 is communicatively coupled to receive those user selections and act upon them, e.g., by applying the set of kinematic parameters associated with the kinematic model 240 to the patient via the electrode array(s) 124. In some implementations, the controller 130 may present user interface that the user 112a/x may use to modify one or more parameters associated with a kinematic model 240 or initiate a modification of the kinematic model 240 (e.g., via interaction with one or more of the neuromodulation inference engine 304 and the neuromodulation LLM 236).

The kinematic model receiver 504 is communicatively coupled to receive a kinematic model 240 from one or more of the neuromodulation LLM inference engine 304 or controller 130. In some implementations, the kinematic model receiver 504 may receive kinematic models and store them in memory 204. In some implementations, the stimulator 120 may store a library of all available kinematic models for a particular patient 112a on that patient’s stimulator 120. In some implementations, the memory 204 of the stimulator 120 may be limited. For example, in some implementations, the memory 204 may be sufficient to only store a subset of the available kinematic models (e.g., only the kinematic model 240 in use, or the kinematic model 240 in use and a number of previously used kinematic models and/or most frequently used kinematic models), and the stimulator 120 may download a different kinematic model 240 to replace the model in use responsive to selection of that different kinematic model.

The stimulation output engine 506 may include software and/or logic for applying electrical parameter sets to the patient 112a via the electrode array 124. For example, the stimulation output engine 506 is communicatively coupled to receive parameters from the neuromodulation LLM inference engine 304, and the stimulation output engine 506 applies the specified parameter values to the specified electrodes. As another example, the stimulation output engine 506 obtains a kinematic model 240 and applies the specified kinematic parameter values to the specified electrodes. For example, the stimulation output engine 506 is communicatively coupled to the kinematic model receiver 504 to obtain a kinematic model 240 and applies the kinematic model 240 to the patient 112a via the electrode array 124.

### Example Methods

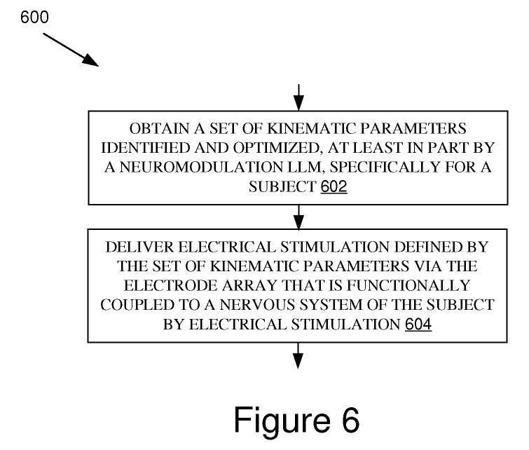

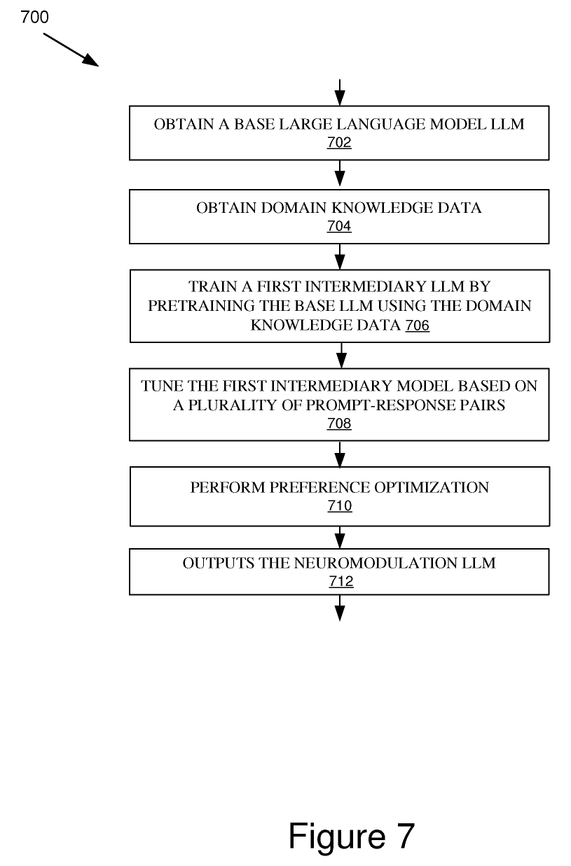

FIGS. 6 and 7 are flowcharts of example methods 600 and 700 that may, in accordance with some implementations, be performed by the systems described above with reference to FIGS. 1A-5. The methods 600 and 700 of FIGS. 6 and 7 are provided for illustrative purposes, and it should be understood that many variations exist and are within the scope of the disclosure herein.

FIG. 6 illustrates a flowchart of an example method 600 for neuromodulation using spinal stimulation and a neuromodulation large language model in accordance with some implementations. The method 600 begins at block 602. At block 602, the stimulator 120 obtains (e.g., via the kinematic model receiver 540) a set of kinematic parameters determined, at least in part by a neuromodulation LLM, specifically for a subject. At block 604, the stimulator 120 (e.g., via the stimulation output engine 506 and the electrode array 124 that is functionally coupled to a nervous system of the subject by electrical stimulation) delivers the electrical stimulation defined by the set of kinematic parameters to the subject.

FIG. 7 illustrates a flowchart of an example method 700 for training a neuromodulation large language model in accordance with some implementations. The method 700 begins at block 702. At block 702, the base LLM obtainer 402 obtains a base large language model LLM. At block 704, the domain data determiner 404 obtains domain knowledge data. At block 706, the neuromodulation LLM pre-trainer 406 trains a first intermediary LLM by pretraining the base LLM using the domain knowledge data. At block 708, the neuromodulation LLM tuning engine 408 tunes the first intermediary model based on a plurality of prompt-response pairs. At block 710, the neuromodulation LLM preference optimizer 420 performs preference optimization. At block 712, the neuromodulation LLM trainer 302 outputs the neuromodulation LLM, e.g., for execution by the neuromodulation LLM inference engine 304.

### Other Considerations

It should be understood that the above-described examples are provided by way of illustration and not limitation and that numerous additional use cases are contemplated and encompassed by the present disclosure. In the above description, for purposes of explanation, numerous specific details are set forth in order to provide a thorough understanding of the present disclosure. However, it should be understood that the technology described herein may be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

Reference in the specification to “one implementation” or “an implementation” or “some implementations” means that a particular feature, structure, or characteristic described in connection with the implementation is included in at least one implementation. The appearances of the phrase “in some implementations” in various places in the specification are not necessarily all referring to the same implementations.

In some instances, various implementations may be presented herein in terms of algorithms and symbolic representations of operations on data bits within computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of a hardware implementation, a software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the system to become coupled to other data processing systems, storage devices, remote printers, etc., through intervening private and/or public networks. Wireless (e.g., Wi-Fi^{TM}) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol / Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As should be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies, engines, and other aspects of the disclosure can be implemented as software, hardware, firmware, or any combination of the foregoing. Also, wherever an element, an example of which is a module, of the specification is implemented as software, the element can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A system comprising:
an electrode array comprising a plurality of electrodes, the electrode array being functionally coupled to a nervous system of a subject by electrical stimulation, the electrical stimulation reducing motor impairment in the subject so that the subject may perform a physiological function; and
a stimulator delivering the electrical stimulation via the electrode array, the electrical stimulation defined by a set of kinematic parameters, wherein:
at least one kinematic parameter in the set of kinematic parameters is:
determined, at least in part, by a neuromodulation large language model (LLM), specifically for the subject; and
responsive to a prompt and based on subject-specific context data; and
when the set of kinematic parameters are delivered to the subject, the subject achieves a physiological function with reduced motor impairment.

2. The system according to claim 1, wherein the subject-specific context data comprises one or more of:
a neuromuscular map specific to the subject;
a kinematic model specific to the subject; and
a patient history representing a subject’s prior interactions with the neuromodulation LLM.

3. The system according to claim 1 comprising:
a processor; and
a memory, the memory storing instructions that, when executed by the processor, cause the system to:
obtain a base large language model LLM;
obtain domain knowledge data;
train a first intermediary LLM by pretraining the base LLM using the domain knowledge data;
tune the first intermediary LLM based on a plurality of prompt-response pairs;
perform preference optimization; and
output the neuromodulation LLM.

4. The system according to claim 3, wherein one or more of the base LLM and the neuromodulation LLM are an open weight model.

5. The system according to claim 3, wherein the base LLM is a self-hosted model selected from one or more of: Large Language Model Meta Artificial Intelligence (Llama), Mistral, Gemma, Qwen, Deepseek, and Command R+.

6. The system according to claim 3, wherein the domain knowledge data comprises one or more of:
curated scientific or clinical literature related to one or more of: neuromuscular rehabilitation, implantable stimulation systems, muscle activation dynamics, and biomechanical motor control;
publications or technical reports describing one or more of: stimulation strategies, rehabilitation protocols, and observed physiological responses;
medical or anatomy texts describing a neuromuscular system;
scientific journals;
textbooks; and
text describing clinical trials.

7. The system according to claim 3, wherein the plurality of prompt-response pairs, include a subset of prompt-response pairs based on the domain knowledge data.

8. The system according to claim 3, wherein the plurality of prompt-response pairs, include a subset of prompt-response pairs based on patient history, the patient history associated with prior prompts associated with one or more patients and prior responses output by one or more of a clinician and a prior version of the neuromodulation LLM.

9. The system according to claim 3, wherein one or more of the tuning and the preference optimization comprise: one or more of supervised fine-tuning, full fine-tuning, parameter-efficient fine-tuning, reinforcement learning from human feedback, direct preference optimization, proximal policy optimization, and odds ratio preference optimization.

10. The system according to claim 1 comprising:
a controller comprising:
a processor; and
a memory, the memory storing instructions that, when executed by the processor, cause the system to:
present, to a user, a user interface;
receive a user prompt via the user interface, wherein the user prompt is a natural language prompt regarding one or more of the subject’s physiological function and the set of kinematic parameters delivered to the subject;
receive a response including the at least one kinematic parameter in the set of kinematic parameters, the at least one kinematic parameter determined, at least in part, by the neuromodulation LLM and modifying a prior value; and
cause the stimulator to deliver the set of kinematic parameters to the subject.

11. A method comprising:
obtaining, at a stimulator, a set of kinematic parameters at least one kinematic parameter determined specifically for a subject, at least in part, by a first machine learning algorithm neuromodulation large language model (LLM) responsive to a prompt and based on subject-specific context data; and
delivering, by the stimulator, electrical stimulation via an electrode array, the electrical stimulation defined by the set of kinematic parameters, wherein the electrode array comprises a plurality of electrodes, the electrode array is functionally coupled to a nervous system of the subject by electrical stimulation, and, subsequent to delivering the electrical stimulation defined by the set of kinematic parameters to the subject, the subject achieves a physiological function with reduced motor impairment.

12. The method according to claim 11, wherein the subject-specific context data comprises one or more of:
a neuromuscular map specific to the subject;
a kinematic model specific to the subject; and
a patient history representing a subject’s prior interactions with the neuromodulation LLM.

13. The method according to claim 11 comprising:
obtaining a base large language model LLM;
obtaining domain knowledge data;
training a first intermediary LLM by pretraining the base LLM using the domain knowledge data;
tuning the first intermediary LLM based on a plurality of prompt-response pairs;
performing preference optimization; and
outputting the neuromodulation LLM.

14. The method according to claim 13, wherein one or more of the base LLM and the neuromodulation LLM are an open weight model.

15. The method according to claim 13, wherein the base LLM is a self-hosted model selected from one or more of: Large Language Model Meta Artificial Intelligence (Llama), Mistral, Gemma, Qwen, Deepseek, and Command R+.

16. The method according to claim 13, wherein the domain knowledge data comprises one or more of:
curated scientific or clinical literature related to one or more of: neuromuscular rehabilitation, implantable stimulation systems, muscle activation dynamics, and biomechanical motor control;
publications or technical reports describing one or more of: stimulation strategies, rehabilitation protocols, and observed physiological responses;
medical or anatomy texts describing a neuromuscular system;
scientific journals;
textbooks; and
text describing clinical trials.

17. The method according to claim 13, wherein the plurality of prompt-response pairs, include a subset of prompt-response pairs based on the domain knowledge data.

18. The method according to claim 13, wherein the plurality of prompt-response pairs, includes on a subset of prompt-response pairs based on patient history, the patient history associated with prior prompts associated with one or more patients and prior responses output by one or more of a clinician and a prior version of the neuromodulation LLM.

19. The method according to claim 13, wherein one or more of the tuning and the preference optimization comprise: one or more of supervised fine-tuning, full fine-tuning, parameter-efficient fine-tuning, reinforcement learning from human feedback, direct preference optimization, proximal policy optimization, and odds ratio preference optimization.

20. The method according to claim 11 comprising:
presenting, to a user, a user interface;
receiving a user prompt via the user interface, wherein the user prompt is a natural language prompt regarding one or more of the subject’s physiological function and the set of kinematic parameters delivered to the subject;
receiving a response including the at least one kinematic parameter in the set of kinematic parameters, the at least one kinematic parameter determined, at least in part, by the neuromodulation LLM and modifying a prior value; and
causing the stimulator to deliver the set of kinematic parameters to the subject.
